(19) United States
(12) Patent Application Publication
(10) Pub. No.: US 2022/0154074 A1
(43) Pub. Date: May 19, 2022

(54) Pyrolysis Reactor and Method

(71) Applicant: Big Atom Limited, London (GB)

(72) Inventor: Alexander Guslisty, London (GB)

(21) Appl. No.: 17/603,532

(22) PCT Filed: Apr. 9, 2020
(86) PCT No.: PCT/EP2020/060292

§ 371 Date: Oct. 13, 2021

(30) Foreign Application Priority Data
Apr. 15, 2019 (GB) 1905320.6

(51) Int. Cl. C10B 19/00; C10B 7/10; C10B 53/02; C10B 53/07; B01J 8/08; B01J 8/10

(52) U.S. Cl. CPC C10B 19/00; C10B 7/10; C10B 53/02; B01J 2208/00513; B01J 8/087; B01J 8/10; C10B 53/07

(57) ABSTRACT

A pyrolysis reactor and process for processing or recycling waste material. The pyrolysis reactor defines an internal cavity, and includes an inlet for the transfer of feedstock material into the internal cavity and an outlet for the transfer of processed material out of the internal cavity. The pyrolysis reactor also includes an induction heating apparatus comprising up to three induction heaters arranged outside of the internal cavity and an induction susceptor within the internal cavity e.g. granules up to 50 mm diameter and/or a helical stirrer including an induction susceptor material. The induction heating apparatus is configured to heat feedstock material within the internal cavity.

The present invention is concerned with a pyrolysis apparatus. More particularly, the present invention is concerned with an improved pyrolysis reactor for processing or recycling waste, for example polymer and plastic waste. The present invention is also concerned with an improved pyrolysis method. More particularly, the present invention is concerned with an improved pyrolysis method for processing or recycling waste, for example polymer and plastic waste.

Pyrolysis is a known process by which materials are decomposed at elevated temperatures. The process has a number of uses, including the depolymerisation of organic or semi-organic materials, for example polymers and plastics. Pyrolysis methods can, therefore, be used to process industrial and domestic waste streams to recover value from disposed polymers and elastomers by the production of petrochemical feedstock, hydrocarbon fuels, as well as the extraction of solid components. The gas or oil produced by pyrolysis can, for example, be used as a fuel for firing a boiler for steam production and subsequent power generation. Petrochemical feedstock that is produced by the process can be used in the production of transportation fuels.

In conventional pyrolysis methods for the treatment of polymer waste, the polymer waste is broken up into granules and fed into a reactor, in which the granules are heated.

In a first stage of the process, the granules are heated to a ‘first’ temperature range in which volatile components that are trapped within the solid complex are vapourised and discharged from the reactor via a gas outlet. Further increasing the temperature causes solid long-chain polymers to decompose into lower molecular weight hydrocarbon reaction products. In a second stage of the process, when the granules reach a ‘second’ temperature point, the reaction products are vapourised and discharged from the reactor. Increasing the temperature further causes the initiation of secondary reactions within the reactor. These secondary reactions result in the yield of liquid product being reduced and the yield of gas product being increased. The secondary reactions also result in a wider distribution of hydrocarbon molecular weights within the liquid product stream. Once all vapours have been extracted, the remaining solid product is discharged from the reactor.

In some pyrolysis reactor systems, hot exhaust gases from an external burner, for example a furnace-style burner, may be directed through a jacket on the outside of the reactor. Heat is transferred from the wall of the reactor to the polymer granules. The granules may be agitated within the reactor in order to improve the transfer of heat between the reactor wall and the granules. In other examples, the reactor may include an internal auger or screw through which an electric current is passed in order to produce heat by Ohmic heating (which is also known as Joule heating or resistive heating). Heat from the auger or screw is used to heat the granules during their passage through the reactor.

In each of the examples described above, the heat source must be operated at temperatures far in excess of the second temperature point in order to achieve effective heat transfer and ensure that the solid phase granules are heated up to the desired temperature. This is energy inefficient.

This also means that the components of the reactor are exposed to very high temperatures and so must meet the required standards for safe operation at those temperatures. This increases the capital cost associated with reactor equipment.

Furthermore, and as explained above, operation of the reactor at very high temperatures increases the likelihood of secondary reactions occurring. The processing and storage of the secondary reaction products further increases the cost of conventional pyrolysis equipment and processes. In particular, the high yield of gas that results from the secondary reactions results in the requirement for reactors and downstream vessels that can hold greater volumes of gas. There is also a requirement for more complex control systems. Each of these factors increase the capital cost requirements and negatively impact the operational efficiency.

The rate at which the material is heated is also known to affect product yield. Higher heating rates, for example, often generate higher yields of liquid. Conversely, lower heating rates generate higher yields of gas. It is difficult to control the rate of heating using conventional reactors.

There is a desire to improve pyrolysis equipment and processes in order to improve energy efficiency and product yield for polymer recycling processes, as well as to reduce the capital expenditure associated with polymer recycling facilities.

Induction heating is used in chemical reactions as an alternative to conduction and microwave heating. US 2012/0215023, for example, describes a chemical process in which the reaction medium is brought into contact with a heating medium that can be heated by electromagnetic induction. This process enables heat to be generated directly within the body of the reactor. When the inductor is switched off, the heat is also switched off. US 2012/0215023 describes how the heating medium is provided in the form of particles, chips, wires, meshes, wool, fillers, or the like. The operating parameters described in US 2012/0215023 are only suitable for ensuring that the reaction takes place in the proximity of the stirrer. The described operating parameters are not suitable for polymer recycling processes.

According to a first aspect of the invention, there is provided a pyrolysis reactor for the processing or recycling of waste material, the pyrolysis reactor defining an internal cavity, and including an inlet for the transfer of feedstock material into the internal cavity and an outlet for the transfer of processed material out of the internal cavity, wherein the pyrolysis reactor includes an induction heating apparatus comprising an induction heater outside of the internal cavity of the pyrolysis reactor and an induction susceptor within the internal cavity of the pyrolysis reactor, the induction heating apparatus being configured to heat feedstock material within the internal cavity.

The induction heating apparatus is advantageously configured to directly heat feedstock material within the internal cavity, thereby improving the energy efficiency of the reactor.

The induction heater may be provided adjacent to an exterior surface of the pyrolysis reactor.

Heat from the induction susceptor can advantageously be used to directly heat material within the pyrolysis reactor. The direct heating of material within the pyrolysis reactor improves the energy efficiency of the heating process and allows greater control over the rate at which the material within the pyrolysis reactor is heated.

The induction heater may extend around a portion of the exterior surface of the pyrolysis reactor. The induction heater may, for example, extend around a circumference of the exterior surface of the pyrolysis reactor.

In some examples, the induction heater is a first induction heater and the induction heating apparatus may include a second induction heater. In such an induction heater, the portion may a first portion and the first induction heater may extend around the first portion of the exterior surface of the pyrolysis reactor. The second induction heater may extend around a second portion of the exterior surface of the pyrolysis reactor.

In some examples of the invention, the induction heating apparatus may include a third induction heater. The third induction heater may extend around a third portion of the exterior surface of the pyrolysis reactor.

The use of two or more induction heaters along the length of the pyrolysis reactor advantageously enables further control over the temperature which the material within the pyrolysis reactor is heated and the rate of heating of the material within the pyrolysis reactor since the material in different regions of the reactor can be heated to different temperatures and/or at different heating rates.

The induction susceptor may include at least one granule including an induction susceptor material. The at least one granule including the induction susceptor material may be a plurality of granules including the induction susceptor material. The induction susceptor material may be a conductive material. The at least one granule may have an effective diameter of at least 1 millimetre. Additionally, or alternatively, the at least one granule may have an effective diameter of up to 50 millimetres.

The at least one granule of induction susceptor material is advantageously sized to facilitate uniform heating of the waste material and to improve the yield of processed material.

The reactor may include a stirrer that is located within the internal cavity. The stirrer may be a helical stirrer. The stirrer may include the induction susceptor material. The stirrer may include an impeller and a plurality of supporting members. The impeller may be formed as a helix, for example a double-helix, or a ribbon. The impeller may include the induction susceptor material. Additionally, or alternatively, at least one supporting member of the plurality of supporting members may include the induction susceptor material.

The induction heater may be configured to provide an alternating current having a frequency of at least 3 Hertz. The induction heater may be configured to provide an alternating current having a frequency of up to 50 megahertz. The induction heater may be configured to provide an alternating current having a frequency of up to 300 kilohertz. Preferably, the induction heater may be configured to provide an alternating current between 20 Hertz and up to 1 kilohertz.

The frequency of the alternating current provided by the induction heater is advantageously selected to facilitate uniform heating of the at least one granule of the susceptor material and/or the induction susceptor material within the stirrer in order to improve the efficiency of the process.

According to a second aspect of the invention there is a pyrolysis method for processing or recycling a waste material within a reactor, the method including the steps of: transferring a feedstock material into an internal cavity of a pyrolysis reactor according to the first aspect of the invention; using the induction heating apparatus to increase the temperature of the feedstock material; and transferring the processed material out of the pyrolysis reactor.

The feedstock material may include one or more of elastomeric materials (saturated and unsaturated) such as tyre rubber, polymeric materials, biomass (such as natural oils or fats, wood, seaweed and algae), coal, or industrial petrochemicals such as waxes, oils (for refining), surfactants, greases, paint or mineral oils. Additionally, or alternatively, the feedstock material may include a mixture of two or more of the above materials.

Examples according to the present invention will now be described with reference to the accompanying Figures, in which:

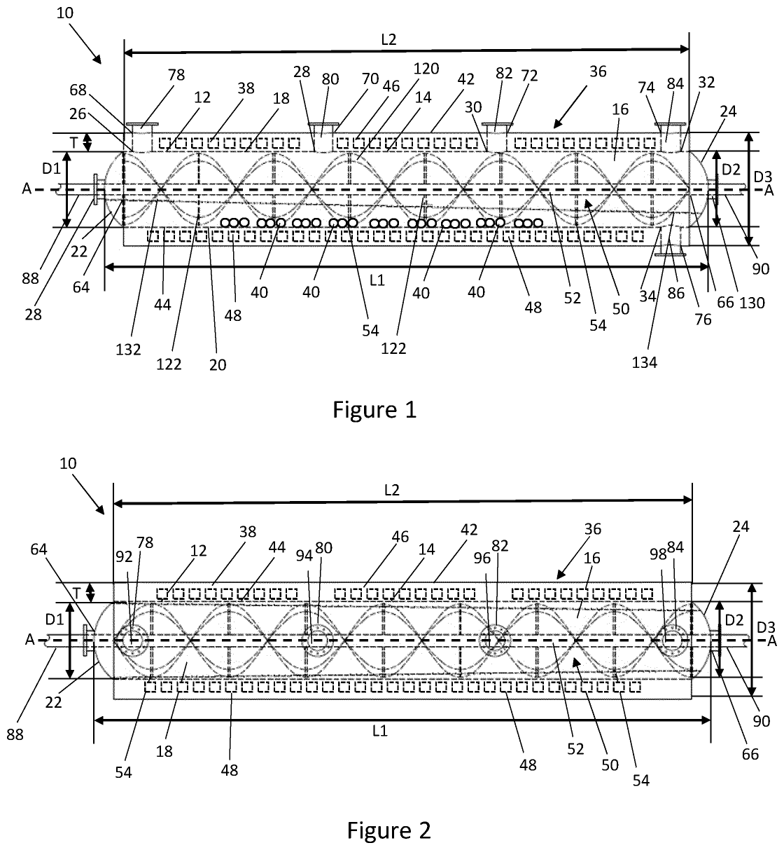

FIG. 1 is a schematic front view of a pyrolysis reactor according to an embodiment of the present invention;

FIG. 2 is a schematic plan view of the pyrolysis reactor of FIG. 1;

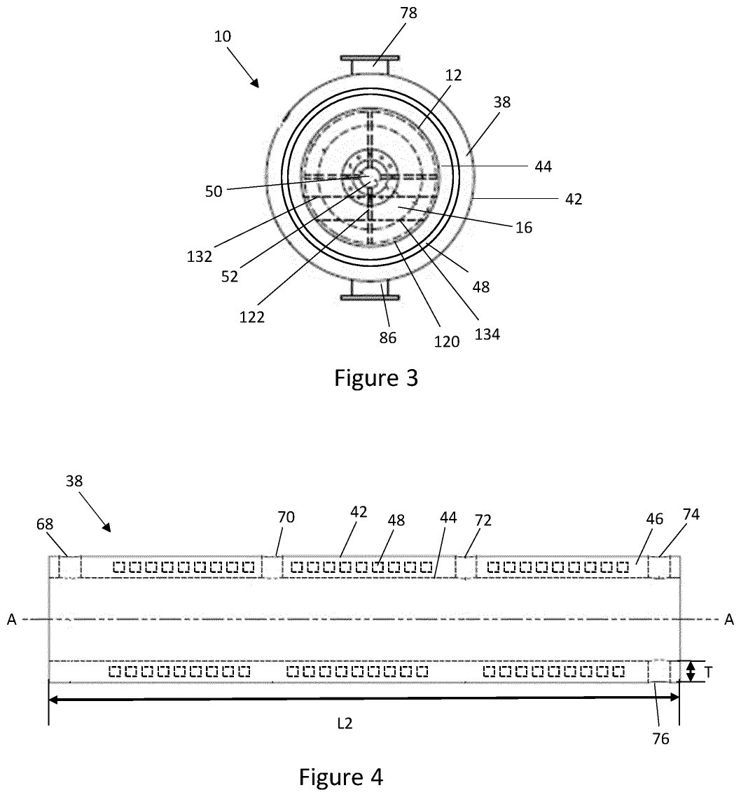

FIG. 3 is a side view of the pyrolysis reactor of FIG. 1;

FIG. 4 is a front view of the induction heater of the pyrolysis reactor of FIG. 1;

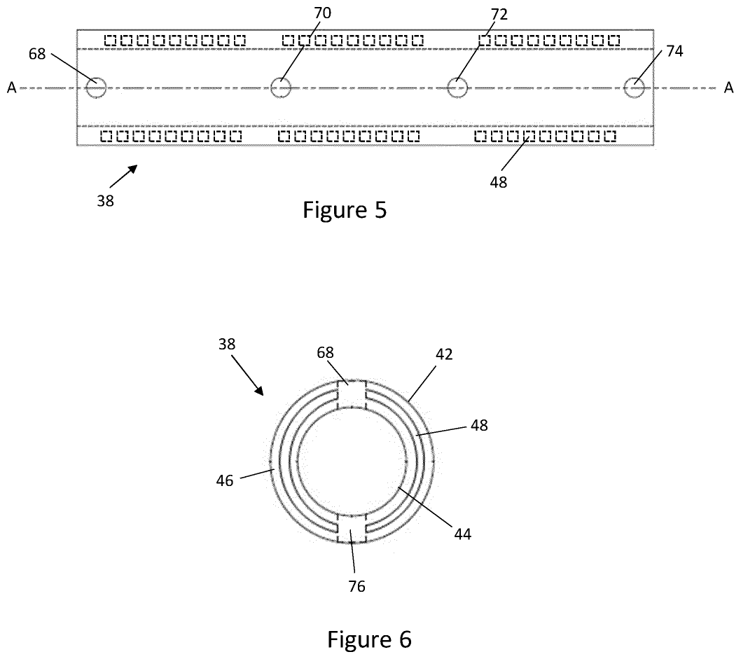

FIG. 5 is a plan view of the induction heater of FIG. 4;

FIG. 6 is a side view of the induction heater of FIG. 4;

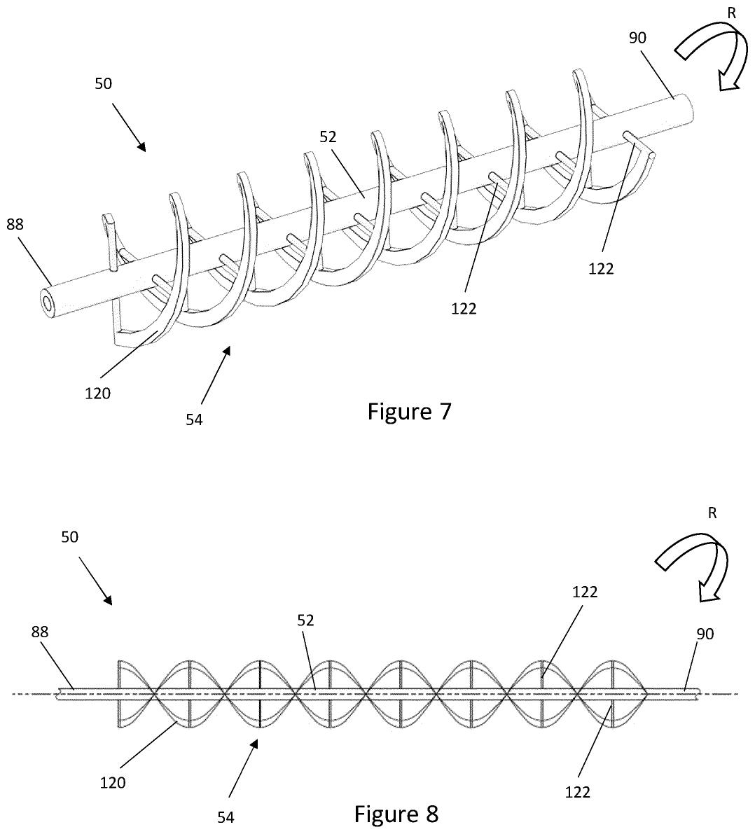

FIG. 7 is a perspective view of the stirrer of the pyrolysis reactor of FIG. 1;

FIG. 8 is a front view of the stirrer of FIG. 7;

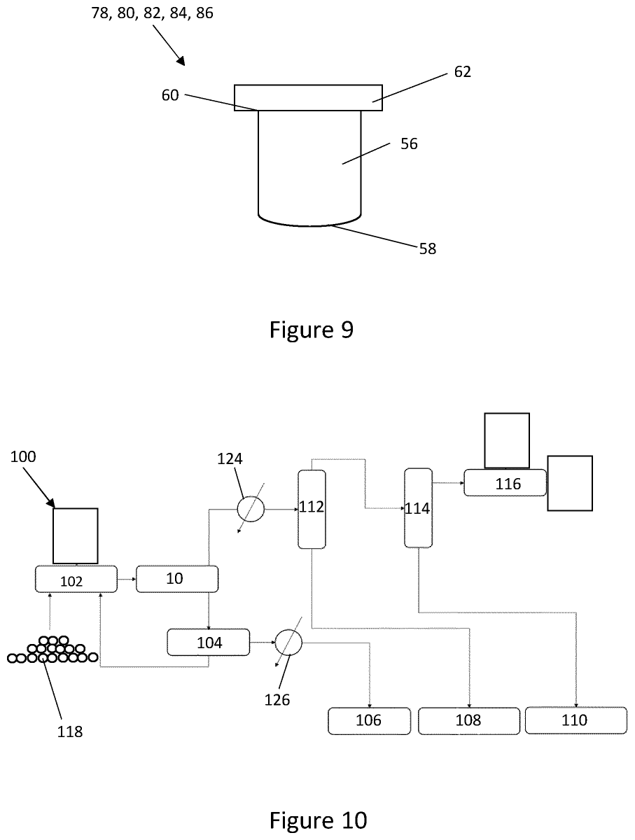

FIG. 9 is a schematic representation of a port for use with the pyrolysis reactor of FIG. 1; and

FIG. 10 is a process diagram for a pyrolysis system including the pyrolysis reactor of FIG. 1.

Referring to FIGS. 1, 2 and 3, there is a pyrolysis reactor 10. The pyrolysis reactor 10 has a generally cylindrical reactor tank 12 that is made from a non-inductive material, for example a non-inductive metal alloy. The reactor tank 12 has an outer wall 14 that defines an internal cavity 16. The outer wall 14 has an arcuate upper surface 18, an arcuate lower surface 20, a first end 22 and a second end 24. The reactor tank 12 has a length L1, a diameter D1 and a longitudinal axis A-A. In some embodiments of the invention, the reactor tank 12 may be 7.5 metres in length and have a diameter of 1 metre.

The reactor tank 12 includes an inlet opening 26 and four outlet or discharge openings 28, 30, 32, 34. The inlet opening 26 and outlet openings 28, 30, 32 are provided in the upper surface 18 of the outer wall 14. The outlet opening 34 is provided in the lower surface 20 of the outer wall 24. The reactor tank 12 also has a side opening 64 at the first end 22 and a side opening 66 at the second end 24.

The pyrolysis reactor 10 has an induction heating apparatus 36. The induction heating apparatus 36 includes an induction heater 38 and induction susceptor granules 40.

With particular reference to FIGS. 4, 5 and 6, the induction heater 38 is provided in the form of a sleeve or jacket having a length L2, an outer surface 42 and an inner surface 44. The induction heater 38 is made from an insulating material, for example a fibrous ceramic material or a glass fibre-reinforced plastic material. A wall 46 having a thickness T is defined between the outer surface 42 and the inner surface 44 of the induction heater 38. An induction source coil 48 made from, for example copper, is included within the wall 46 of the induction heater 38. The induction heater 38 also includes an inlet opening 68 and a plurality of outlet openings 70, 72, 74, 76.

The induction susceptor granules 40 may be made from any suitable inductive material, for example stainless steel or a similar high grade alloy, e.g. including zirconia or yttria elements, or a non-oxidising metal alloy. In their simplest form the induction susceptor granules 40 would be spherical or substantially spherical. The granules 40 may, for example, have an effective diameter in the range of approximately 1 millimetre to approximately 50 millimetres.

The pyrolysis reactor 10 has a stirrer in the form of helical stirrer 50. With particular reference to FIGS. 7 and 8, the helical stirrer 50 has a central spindle 52 having a first end 88 and a second end 90. As shown in FIG. 1, the central spindle 52 extends along axis A-A of the reactor tank 12. An impeller 54 in the form of a double-helix or ribbon 120 and a plurality of supporting members in the form of spindles 122 extends along the length of the central spindle 52. The impeller 54 is constructed such that the plurality of spindles 122 extend outwardly from the central spindle 52 and support the position of the double-helix or ribbon 120 around the periphery of the central spindle 52.

The pyrolysis reactor 10 also includes an inlet or feed port 78 and a plurality of outlet or discharge ports 80, 82, 84, 86.

Each of the ports 78, 80, 82, 84, 86 is made from the same material as the reactor tank 12. The ports 78, 80, 82, 84, 86 are of the same construction and will be described with particular reference to FIG. 9. The ports 78, 80, 82, 84, 86 have a hollow cylindrical body 56 that a first end 58 and a second end 60. A flange 62 is provided at the second end 60.

Assembly of the pyrolysis reactor 10 will now be described.

The helical stirrer 50 is installed within the reactor tank 12 such that the spindle 52 of the stirrer is positioned along the longitudinal axis A-A of the reactor tank 12, the first end 88 of the spindle 52 extends through the side opening 64 of the reactor tank 12 and the second end 90 of the spindle 52 extends through the side opening 66 of the reactor tank 12. A motor (not shown) is provided at one end of the spindle 52. A first seal 128 is provided at the first end 22 of the tank and a second seal 130 is provided at the second end 24 of the tank.

An insulation layer (not shown), for example made from, for example a fibrous ceramic material or a glass fibre-reinforced plastic material, is fixed to the outer wall 14 of the reactor tank 12. The insulation layer ensures that the current within the coil 48 is isolated. The induction heater 38 is placed around the outer wall 14 of the reactor tank 12 such that the inner surface 44 of the induction heater jacket 38 is in contact with the insulation layer (not shown). The induction heater jacket 38 thus has an inner diameter D2 that is the substantially the same as the diameter D1 of the reactor tank 12 and an outer diameter D3 that is greater than the diameter D1 of the reactor tank 12. The induction heater jacket 38 is aligned with the reactor tank 12 such that the inlet or feed opening 26 of the reactor tank 12 is aligned with the inlet or feed opening 68 of the induction heater jacket 38. Similarly, the outlet or discharge openings 28, 30, 32, 34 of the reactor tank 12 are aligned with the outlet or discharge openings 70, 72, 74, 76 of the induction heater jacket 38. Once the induction heater jacket 38 is in the correct position on the reactor tank 12, the induction heater jacket 38 is fastened in position. A shielding jacket (not shown) may be installed around the coil and positioned such that it is not in contact with the coil.

The inlet or feed port 78 is installed on the pyrolysis reactor 10 such that the hollow cylindrical body 56 extends through the inlet opening 68 of the induction heating jacket 38 and the inlet opening 26 of the reactor tank 12. In this position, the first end 58 of the body 56 is positioned adjacent to the outer wall 14 of the reactor tank and the second end 60 of the body 56 is positioned adjacent to the outer surface 42 of the induction heater jacket 38 and the hollow cylindrical body 56 of the inlet port 78 is in fluid communication with the internal cavity 16 of the reactor tank 12.

The outlet or discharge ports 80, 82, 86, 86 are similarly installed on the pyrolysis reactor 10 through the outlet openings 70, 72, 74, 76 of the induction heating jacket 38 and the outlet openings 28, 30, 32, 34 of the reactor tank 12.

The pyrolysis reactor 10 is installed within a pyrolysis system 100, an example of which is shown in FIG. 10.

The exemplary pyrolysis system 100 includes a feeder 102, a solids separator 104, a first condenser 112, a second condenser 114 and a gas burner 116. The pyrolysis system 100 further includes storage means 106, 108, 110. A first heat exchanger 124 is positioned between the pyrolysis reactor 10 and the first condenser 112. A second heat exchanger 126 is positioned between the solids separator 104 and the storage means 106.

Operation of the pyrolysis reactor will now be described with reference to FIG. 10.

Material, for example polymer waste such as waste tyres, is shredded into feedstock granules 118 in the range of approximately 1 millimetre to approximately 50 millimetres. The feedstock granules 118 are sized to be substantially the same size as the susceptor granules 40. The feedstock granules 118, together with inert gas and the susceptor granules 40, are transferred to the feeder 102. The feeder 102 is connected to the pyrolysis reactor 10 via the inlet port 78. In this way a mixture of feedstock granules 118 and susceptor granules 40 (the granulate mixture) is fed into the reactor tank 12. The granulate mixture occupies the reactor tank 12 to a first level 132 at the first end 22 of the reactor tank 12 and to a second level 134 at the second end 24 of the reactor tank 12. The orientation of the reactor tank 12 and rotational stirring action of the helical stirrer 50 in the direction R, which is clockwise if looking along the longitudinal axis A-A from the first end 88 of the spindle 52 to the second end 90 of the spindle 52, facilitates the movement of material within the reactor tank towards the outlet port 86.

An alternating current (for example 2000 to 3000 Amperes at a frequency of 3 hertz to 50 megahertz, for example at a frequency between 3 Hertz and 300 kilohertz, preferably at a frequency between 20 Hertz and 1 kilohertz) is applied to the induction source coil 48 such that a varying invisible electromagnetic field (not shown) is induced by the induction source coil 48. The induction source coil 48 is arranged such that the invisible varying electromagnetic field has maximum strength and is localised to the reactor tank 12 and, in particular, to the internal cavity 16 of the reactor tank 12.

The invisible varying electromagnetic field (not shown) further induces a current in susceptor granules 40. The frequency of the alternating current is preferably up to 1 kilohertz in order to achieve uniform heating of the susceptors, as well as the granulate mixture. The susceptor granules' 40 inherent resistance to current results in the susceptor granules 40 heating up to the required temperature, for example 600° C. No direct contact between the induction source coil 48 and the susceptor granules 40 is required. However, the closer susceptor granules 40 get to induction source coil 48, the more effective the heating of the susceptor granules 40. Therefore, rotation of helical stirrer 40 about axis A-A in the direction R, caused by the motor (not shown), ensures that the susceptor granules 40 are positioned in close proximity to induction source coils 48 as the susceptor granules 40 travel within reactor cavity 16.

The direct contact between the susceptor granules 40 and the feedstock granules 118 causes the feedstock granules 118 to be heated to the required temperature (for example 600° C.) by a combination of radiation and conduction, as well as convection as a result of the hot vapours flowing around the granules. The helical stirrer 50 rotates about axis A-A in a direction R (as shown in FIGS. 7 and 8) to ensure good mixing between the susceptor granules 40 and feedstock granules 188. This advantageously improves the transfer of heat throughout the granulate mixture, optimising the reaction kinetics of the pyrolysis process within the feedstock granules 118 and limiting secondary reactions within the vapour phase (not shown) present in the reactor tank 12.

The direct heating of the feedstock granules 118 provided by the susceptor granules 40, allows the granulate mixture to be heated rapidly. The time that the granulate mixture spends in the first temperature range (for example 100° C. to 300° C.) is thus limited and so the production of unwanted products, for example dioxins, is limited.

As the temperature of the mixture can be controlled, secondary reactions within the reactor tank 12 can be prevented and thus the distribution of molecular weights within the solid product can be more accurately controlled.

The pyrolysis reactor 10 advantageously enables the heating efficiency of the pyrolysis process to be improved, reduces the complexity of process control and is more compact than conventional pyrolysis reactors designed to treat the same throughput of material.

Such a system also advantageously facilitates co-pyrolysis of feedstock granules formed from a heterogeneous mixture of polymers.

Gaseous products that are produced in the reactor tank 12 are passed through a cooler and into the first condenser 112, from which heavy condensate can be collected and stored in storage means 108, and the second condenser 114, from which light condensate can be collected and stored in storage means 110. The remaining gas, together with air, can be burnt in the gas burner 116 and vented.

Solid products that are produced in the reactor tank 12 are passed through the solids separator 104 in order for the susceptor granules 40 to be recovered and returned to the feeder 102 and the final product transferred to the storage means 106.

Variations fall within the scope of the present invention.

In the embodiment described, induction susceptors were provided in the form of susceptor granules 40. In alternative embodiments of the invention, susceptor material may be incorporated into the stirrer 50, for example in the impeller 54 of the stirrer 50. In some embodiments of the invention, susceptor material may be provided within the reactor tank 12 in the form of susceptor granules 40 as well as part of the stirrer 50, for example in the impeller 54 of the stirrer 50. In some examples of the invention, the induction susceptor material may be provided within the helix or ribbon 120 of the impeller 54. Additionally, or alternatively, the induction susceptor material may be provided within one or more of the supporting members or spindles 122. In this way, heating of the feedstock material 118 may further be improved during mixing of the contents of the reactor tank 12. In yet further embodiments of the invention, the induction susceptor material may be fixed within the internal cavity 16 of the reactor tank 12. In each of these embodiments, the need to remove susceptor granules 40 from the solid product following treatment of the feedstock material is eliminated, thereby simplifying the process.

In alternative embodiments of the invention, the feedstock material 118 may be pre-treated with susceptor material, for example by injecting or spraying induction susceptor material into the feedstock material or coating the granules of feedstock material 118 with induction susceptor material.

In alternative embodiments of the invention, the reactor tank 12 may be provided without a stirrer 50.

In the embodiment described, the impeller 54 is the form of a double-helix or ribbon 120 having a plurality of supporting members in the form of spindles 122 extending along the length of the central spindle 52. It will be understood that in alternative embodiments the impeller may be in the form of a single helix or have any number of helices.

In the embodiment described a single motor is provided at one end of the spindle of the stirrer. In alternative embodiments of the invention, a motor may be provided at each end of the stirrer.

In the embodiment of the invention described above, a single induction heater jacket 38 is provided. In alternative embodiments of the invention, more than one induction heater jacket may be provided. In such a system, the induction heater jackets may be arranged along the length of the reactor tank 12 and controlled to operate at different temperatures and thus create zones within the reactor tank in which the feedstock granules are heated to different temperatures.

In the embodiment described, the induction heating apparatus 36 extends around the full circumference of reactor tank 12. In an alternative embodiment, the induction heating apparatus 36 extends only partially around the circumference of reactor tank 12. In this arrangement, induction sources 48, are modified as loops (not shown).

In the embodiment described, the reactor tank 12 has a single inlet and four outlets. It will be understood that the reactor tank may include any number of inlets and/or outlets in order to optimise the pyrolysis process.

In the embodiment described, the remaining gaseous product is burned in a gas burner 116. In alternative embodiments of the invention, the remaining gaseous product may be used to generate electricity to power the induction heating via a gas turbine. The operating temperature may be increased and/or the rate of heating may be decreased, for example, in order to increase the volume of gas generated for power generation applications.

The pyrolysis system 100 of FIG. 10 includes two heat exchangers 124, 126. In some examples, a heat exchanger may be provided between the first condenser 112 and the second condenser 114.

In the embodiment described, the reactor tank 12 is manufactured from a non-inductive material. It will be understood that, in alternative embodiments of the invention, the reactor tank could be manufactured from a material that is less inductive than the susceptor material.

1. A pyrolysis reactor for the processing or recycling of waste material, the pyrolysis reactor defining an internal cavity, and including an inlet for the transfer of waste material into the internal cavity and an outlet for the transfer of processed material out of the internal cavity, wherein the pyrolysis reactor includes an induction heating apparatus comprising an induction heater outside of the internal cavity of the pyrolysis reactor and an induction susceptor within the internal cavity of the pyrolysis reactor, the induction heating apparatus being configured to directly heat feedstock material within the internal cavity.

2. A pyrolysis reactor according to claim 1, wherein the induction heater is provided adjacent to an exterior surface of the pyrolysis reactor.

3. A pyrolysis reactor according to claim 1, wherein the induction heater extends around a portion of the exterior surface of the pyrolysis reactor.

4. A pyrolysis reactor according to claim 3, wherein the induction heater extends around a circumference of the exterior surface of the pyrolysis reactor.

5. A pyrolysis reactor according to claim 1, wherein the induction heater is a first induction heater and the induction heating apparatus includes a second induction heater.

6. A pyrolysis reactor according claim 5, wherein the induction heater extends around a portion of the exterior surface of the pyrolysis reactor and wherein the portion is a first portion and the first induction heater extends around the first portion of the exterior surface of the pyrolysis reactor, and wherein the second induction heater extends around a second portion of the exterior surface of the pyrolysis reactor.

7. A pyrolysis reactor according to claim 6, wherein the induction heating apparatus includes a third induction heater.

8. A pyrolysis reactor according to claim 7, wherein the third induction heater extends around a third portion of the exterior surface of the pyrolysis reactor.

9. A pyrolysis reactor according to claim 1, wherein the induction susceptor includes at least one granule including an induction susceptor material.

10. A pyrolysis reactor according to claim 9, wherein the at least one granule including the induction susceptor is a plurality of granules including the induction susceptor material.

11. A pyrolysis reactor according to claim 9, wherein the at least one granule has an effective diameter of at least 1 millimetre.

12. A pyrolysis reactor according to claim 9, wherein the at least one granule has an effective diameter of up to 50 millimetres.

13. A pyrolysis reactor according to claim 1, wherein the pyrolysis reactor includes a stirrer that is located within the internal cavity.

14. A pyrolysis reactor according to claim 13, wherein the stirrer is a helical stirrer.

15. A pyrolysis reactor according to claim 13, wherein the stirrer includes an induction susceptor material.

16. A pyrolysis reactor according to claim 15, wherein the stirrer includes an impeller and a plurality of supporting members.

17. A pyrolysis reactor according to claim 16, wherein the impeller includes the induction susceptor material.

18. A pyrolysis reactor according to claim 16, wherein at least one supporting member of the plurality of supporting members includes the susceptor material.

19. A pyrolysis reactor according to claim 1, wherein the induction heater is configured to provide an alternating current having a frequency of at least 20 Hertz.

20. (canceled)

21. A pyrolysis method for processing or recycling a waste material within a reactor, the method including the steps of: transferring a feedstock waste material into an internal cavity of a pyrolysis reactor as defined by claim 1; using the induction heating apparatus to increase the temperature of the feedstock material; and
transferring the processed material out of the pyrolysis reactor.
